(19) United States
(12) Patent Application Publication
(10) Pub. No.: US 2005/0019549 A1
(43) Pub. Date: Jan. 27, 2005

(54) Recyclable reinforced polymer foam composition

(76) Inventors: Eva F. Tai, Midland, MI (US); Creston D. Shmidt, Midland, MI (US); Jack A. Broering, Midland, MI (US); Ernest J. Herst, Midland, MI (US)

Correspondence Address: THE DOW CHEMICAL COMPANY;INTELLECTUAL PROPERTY SECTION, P. O. BOX 1967, MIDLAND, MI, 48641-1967, US

(21) Appl. No.: 10/885,939

(22) Filed: Jul. 6, 2004

Related U.S. Application Data
(60) Provisional application No. 60/489,748, filed on Jul. 24, 2003.

(51) Int. Cl. B32B 3/26; B32B 3/00; B32B 7/12; B32B 27/00

(52) U.S. Cl. 428/315.9; 428/304.4; 428/319.7

(57) ABSTRACT

Reinforced polymeric foam compositions having a polymeric foam core and a structurally reinforcing facer that are recyclable and can contain venting means between the foam and facer. The structurally reinforcing facer contains a thermoplastic polymer film layer and a gas-breathable layer between the foam core and the thermoplastic polymer film layer. The reinforcing facer is free of a polyethylene terephthalate layer, a metal foil layer, a paper layer, or any combination thereof.

### CROSS REFERENCE STATEMENT

This application claims the benefit if U.S. Provisional Application No. 60/489,748, filed Jul. 24, 2003.

### BACKGROUND OF THE INVENTION

1. Field of the Invention

The present invention relates to a recyclable polymeric foam composition that contains a polymeric foam core with a structurally reinforcing composite facer that reinforces the foam against breaking.

2. Description of Related Art

Common construction practice currently includes applying relatively thin (about 0.25 inches to about two inches thick) rectangular panels of foam board to building structure walls in an attempt to improve thermal insulation of resulting building structures. The building trade refers to such panels as “residential foam sheathing”, or “RFS”. Foam boards that are suitable for such applications include extruded polystyrene foam boards, molded expanded polystyrene foam (also known as “MEPS”) boards, and polyisocyanurate foam boards.

RFS boards, while improving thermal insulation performance of a building structure wall, are prone to physical damage from cracking or breaking. Damage may occur by a variety of means including acts of vandalism, high velocity winds, and construction practices. Ladders that lean against vertical walls tend to bend or break attached foam boards, especially with the added weight of construction personnel. Construction personnel who kneel upon foam boards attached to horizontal walls while assembling them prior to vertical erection also can cause damage.

RFS often contains facing materials, or facers, on at least one primary surface of a foam board to provide additional strength. Examples of such facing materials include thermoplastic films, metal foil, paper, fiberglass scrims, and combinations thereof. U.S. Pat. No. 5,695,870 and U.S. Pat. No. 6,358,599 disclose particularly environmentally friendly RFS compositions that use thermoplastic film facers and that are recyclable. Recyclable compositions can be ground up and melt blended with virgin polymer to form a foamable resin blend suitable for forming a new thermoplastic foam. Recyclability is particularly desirable to maximize responsible environmental stewardship by minimizing waste.

There are challenges with current RFS compositions. For example, facers that are desirable for reinforcement (e.g., polyethylene terephthalate (PET), paper, glass fiber and fiberglass scrims) tend to be difficult to recycle with a thermoplastic foam in appreciable quantities, if at all. Therefore, selection of facing materials often requires a compromise between reinforceability and recyclability. Also, RFS compositions containing a polymeric film facer can suffer from localized delamination of the facer from a foam's surface. Delamination can appear as bumps or raised contours on a RFS composition surface. Builders can view such delamination as aesthetically undesirable and, when extreme, detrimental or defective.

A recyclable composition comprising a polymeric foam core and a reinforcing facer (foam/facer composition) that has an enhanced durability over compositions comprising only film facers is desirable. A recyclable foam/facer composition that has a lower likelihood of facer delamination than current RFS compositions with polymeric film facers is also desirable.

### BRIEF SUMMARY OF THE INVENTION

The present invention advances the art of foam insulation by providing a composition containing a thermoplastic foam and a composite facer that meets one or more of the aforementioned desirable characteristics.

In a first aspect, the present invention is a reinforced polymer foam composition comprising a closed-cell foam core having opposing first and second primary surfaces and a structurally enhancing composite facer attached to at least one of the primary surfaces, said composite facer comprising a thermoplastic polymer film layer and a gas-breathable layer, the gas-breathable layer residing between said foam core and said thermoplastic polymer film, and wherein: (a) said foam core comprises a thermoplastic polymer resin having a plurality of cells defined therein, said resin containing at least 50 weight-percent, by weight of resin, of a polymer selected from a group consisting of alkenyl aromatic polymers and polypropylene; (b) said reinforced polymer foam composition is recyclable into a foam core according to a Recylability Test; and (c) said reinforced polymer foam composition is free of a polyethylene terephthalate film layer, a metal foil layer, a layer of paper, or any combination thereof.

In a second aspect, the present invention is a process for preparing the reinforced polymer foam composition of the first aspect, said process comprising affixing the structurally enhancing composite facer comprising the thermoplastic polymer film layer and the gas-breathable layer to a primary surface of the foam core such that the gas-breathable layer is between the thermoplastic polymer film layer and the foam core.

In a third aspect, the present invention is a process for using the reinforced polymer foam composition of the first aspect comprising affixing the reinforced polymer foam composition to a building structure.

### BRIEF DESCRIPTION OF DRAWINGS

FIG. 1 shows a cross-sectional view of a reinforced polymer foam composition of the present invention that contains venting channels above a primary surface of a foam core.

### DETAILED DESCRIPTION OF THE INVENTION

Reinforced polymer foam compositions of the present invention comprise a composite facer affixed to a polymeric foam core. Both the reinforced polymer foam composition (“RPFC”) and thermoplastic polymer foam core (“foam core”) have opposing first and second primary surfaces. At least one of the primary surfaces (the first primary surface) is a surface having the largest planar surface area of the RPFC or foam. Planar surface area corresponds to the surface area of a projection of a surface onto a plane without changing magnification of the surface dimensions. Opposing primary surfaces are usually of similar dimensions and desirably are parallel to one another. Primary surfaces of a foam core are preferably substantially planar. A “substantially planar” primary surface is free of any point lying more than 0.138 inches (in.) (3.5 millimeters (mm)), preferably more than 0.078 in. (two mm), more preferably more than 0.0394 in. (one mm) away from a straight line through any two points on the primary surface as measured perpendicularly from the primary surface. For foam boards and sheets comprising multiple coalesced extruded foam strands, draw the straight line in the foam's extrusion direction (i.e., along the strands).

RPFC and foam cores each have a thickness corresponding to a distance separating the first and second primary surfaces. Measure the thickness perpendicularly from the first primary surface. Theoretically, a RPFC and a foam core can have any thickness. Foam cores can be as thin as 10 mils, but are generally 100 mils or more thick. For RFS applications, the foam core is generally 0.125 inches or more, preferably 0.25 inches or more, and generally 5 inches or less, preferably 2 inches or less in average thickness. An “average thickness” is the average of a foam core's thickness measured at its thickest and thinnest points. Increasing the thickness of a foam core typically increases the thermal insulating ability of the foam core. Reducing a foam core's thickness, thereby creating a thinner foam core, tends to increase foam flexibility. Thinner foam cores are also typically less expensive per square foot than thicker foam cores.

The foam core comprises a thermoplastic polymer having a multitude of cells defined therein. Thermoplastic polymers are reversibly plasticizable, which means they can reversibly soften to form a viscous polymer fluid. Typically, thermoplastic polymers are heat plasticizable, i.e., form a viscous polymer fluid upon heating above their glass transition temperature (T_{g}) or, for crystalline polymers, crystalline melting point (Tₘ). Alkenyl aromatic polymers and copolymers, aliphatic polymers and copolymers, and blends thereof are all suitable as thermoplastic polymers for foam cores of the present invention. For convenience, “polymer” refers to both a homopolymer and a copolymer unless the use specifically states otherwise.

Desirable alkenyl aromatic polymers comprise polymerized monomers containing an aryl group and an unsaturated olefinic group. Exemplary alkenyl aromatic polymers include polymers of styrene, alpha-methylstyrene, ethyl styrene, chlorostyrene, and bromostyrene. Alkenyl aromatic polymers also include alkenyl aromatic polymers having copolymerized or grafted thereon monoethylenically unsaturated compounds such as C₂₋₆ alkyl acids and esters, ionomeric derivatives, and C₄₋₈ dienes. Alkenyl aromatic polymers include copolymers resulting from copolymerizing into or grafting onto an alkenyl aromatic polymer backbone one or more component selected from a group consisting of acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate, isoprene and butadiene. Polystyrene (i.e., a polymer containing greater than 50% of polymerized styrene, by total weight of polymer) is a particularly desirable alkenyl aromatic polymer.

Desirable aliphatic polymers comprise polymerized non-aromatic unsaturated monomers and include, e.g., polyethylene, and polypropylene. “Polyethylene” includes both ethylene homopolymer and copolymers containing at least 50 weight-percent (wt %) polymerized ethylene units, by weight of total polymer. Exemplary polyethylene polymers include low density polyethylene (LDPE), medium density polyethylene (MDPE), high density polyethylene (HDPE), very low density polyethylene (VLDPE), linear low density polyethylene (LLDPE), metallocene-catalyzed linear low density polyethylene (mLLDPE) and combinations thereof. A description of each of these types of polyethylene is available in U.S. Pat. No. 6,536,176 B1 (column 3, line 26 through column 4, line 25; incorporated herein by reference). “Polypropylene” includes polymers containing at least 50 weight-percent (wt %) polymerized propylene units by weight of the polymer. Propylene polymers include propylene homompolymers and copolymers of propylene with other aliphatic polyolefins such as ethylene, 1-butene, 1-pentene, 3-methyl-1-butene, 4-methyl-1-pentene, 4-methyl-1-hexene, 5-methyl-1-hexene and mixtures thereof.

Foams of polypropylene and polystyrene are particularly desirable as thermoplastic foam cores for use in the present invention. Polypropylene foams tend to be especially thermally stable and chemically inert compared to other polymer foams, such as polyethylene foams. Polystyrene foams generally offer higher compressive strength and higher insulating values (R-values) than aliphatic polymer foam (e.g., polyethylene foam).

Foam cores of the present invention are preferably essentially free of materials selected from a group consisting of thermosetting polymeric materials, and thermoplastic polymers with crystalline melting points or glass transition temperatures greater than 200 degrees Celsius (° C.), such as polyethylene terephthalate (PET) and nylon, unless the materials are present as particulates with each particulate being less than one cubic millimeter in volume. A foam core is “essentially free” of these materials if the material, if present, is present at a low enough concentration to have a negligible effect on recyclability of the RPFC into a foam. More preferably, foam cores of the present invention are completely free of any or all of the materials in this paragraph.

Foam cores can be of any conceivable form including extruded foam board or sheet and expanded foam board or sheet (e.g., MEPS). Extruded foams include essentially uniformly extruded structures as well as coalesced foam strand and coalesced foam sheet structures. Extruded polymer foam preparation generally involves heating a polymer material to form a plasticized melt polymer material, incorporating therein a blowing agent to form a foamable gel, and extruding the foamable gel through a die to a zone of lower pressure to form a foam product. Methods for preparing extruded foam are well-known in the art (see, e.g., U.S. Pat. No. 6,358,599 column 7, line 57 through column 8, line 16; incorporated herein by reference). Formation of coalesced strand foam is also well known in the art (see, e.g., U.S. Pat. No. 6,197,233 and U.S. Pat. No. 6,440,241, both of which are incorporated herein by reference). Form expanded foam board and sheet foams by expanding polymeric beads that contain a blowing agent while molding the expanding beads into articles of a desired shape (e.g., a sheet or board). Methods for forming expanded foam boards and sheets are also well known in the art (see, e.g., U.S. Pat. No. 3,154,604 and U.S. Pat. No. 3,060,513, both of which are incorporated herein by reference). Foam cores can comprise a combination of more than one foam element, e.g., a laminate of foam sheets, boards or a combination thereof. Foam cores can comprise a combination of different types of foam, e.g., a laminate of extruded foam sheet and foam bead board or a laminate of a polystyrene foam sheet or board with polyethylene foam sheet or board.

Foam cores can be opened-cell or closed-cell foams, but preferably are closed-cell foams. Closed-cell foams provide optimal thermal insulation and moisture resistance. A closed-cell foam has less than 20 percent (%) open-cell content and preferably less than 10% open-cell content according to American Society for Testing and Materials (ASTM) method D2856-A.

Foam cores can have any conceivable cell size distribution including uniform and multimodal, particularly bimodal, cell size distributions. Foams having multimodal, particularly bimodal, cell size distributions are advantageous because they tend to have lower thermal conductivities than foams having uniform cell size distributions. Foams that have an essentially uniform cell size distribution desirably have an average cell size of about 0.05 millimeters (mm) or more, preferably about 0.1 mm or more, more preferably about 0.2 mm or more and of about 5 mm or less, preferably about 3 mm or less, more preferably about 1 mm or less, still more preferably 0.5 mm or less. An “average cell size” is the average of 20 randomly selected cells of a foam cross section, with cell size determined according to ASTM D3576-77.

Foam cores have a density of about 0.5 pounds per cubic foot (PCF) or more, preferably of about 1 PCF or more. Foam cores having a density below about 0.5 PCF tend to have an undesirably low structural integrity. Foam cores have a density that is less than the resin composition comprising the foam. Generally, a foam core has a density of about 3 PCF or less, more typically about 2 PCF or less. Measure density according to ASTM method D1622.

RPFCs of the present invention contain a composite facer comprising at least two layers, a thermoplastic polymer film layer and a gas-breathable layer, affixed to at least one primary surface of a foam core. Preferably, RPFCs have a composite facer affixed to opposing first and second primary surfaces of a foam core. The composite facer(s) have a smaller dimension in the foam core's thickness direction than the foam core (i.e., a composite facer is thinner than the foam core to which it is affixed).

A composite facer serves to enhance a foam core's strength. Therefore, increasing the amount of composite facer in a RPFC will generally increase the RPFCs strength, assuming adhesion of a composite facer to a foam core does not simultaneously diminish. Depending on the composition of the foam core and composite facer, increasing the amount of composite facer in an RPFC can also hinder recyclability of the RPFC into a foam core. Therefore, the amount of composite facer in a RPFC depends upon selection of facer and foam composition as well as desired strength of the RPFC. An upper limit as to what amount of a RPFC can be facer is limited primarily by what will render the RPFC recyclable. The lower limit as to what amount of a RPFC can be facer is limited primarily by what will structurally enhance the polymeric foam core.

In general, an RPFC with a 0.5-inch thick polymeric foam core will comprise 2.5 wt % or more, preferably 5 wt % or more, more preferably 10 wt % or more and 50 wt % or less, preferably 40 wt % or less, more preferably 30 wt % or less of a composite facer, based on total RPFC weight. As a general guideline, assume a similar weight of composite facer for thicker or thinner foams and adjust weight percentages to account for increased or decreased foam weight.

Average adhesion strength between the composite facer and the foam core is at least about 25 grams per inch (g/in), preferably at least about 50 g/in, more preferably at least 75 g/in, still more preferably at least 100 g/in. Measure “average adhesion strength” according to a Facer Adhesion Strength Test Method (FASTM).

The FASTM measures the necessary force to peel back a one-inch wide strip of facer at a 180° angle at a rate of 10-inches per minute. Cut a seven-inch by three-inch sample of faced foam (e.g., RPFC) such that the seven-inch dimension is in the extruded direction of the foam, if the foam is an extruded foam. Score two lines through the facer but not through the foam of the test sample using a razor to define a one-inch wide strip along the seven-inch dimension. Peel back approximately four inches of the one-inch wide strip of facer from the foam's surface. Repeat on the opposing surface if it also has a facer. Condition the test sample for at least one hour at 73±4° F. and 50±5% relative humidity and test under the same conditions. Conduct the test using a tensile tester (e.g., INSTRON model 1125 or equivalent) with a load cell range to 10 pounds and a display capable of indicating load in grams. Outfit the tensile tester with a crosshead grip and a stationary grip. Place the delaminated portion of facer film into the crosshead grip and the remaining test sample in the stationary grip. Delaminate the one-inch strip of facer at a crosshead rate of ten inches per minute until one additional inch of the strip delaminates. Ensure there is no ink (e.g., from printing on the foam's surface) between the facer and foam primary surface in the additional one inch of delamination. Record the average peel strength for delaminating the additional one inch of the facer strip.

Determine one average peel strength from three portions of a faced foam (e.g., RPFC)—one portion proximate to opposing edges of the foam and one central to the foam—for a total of three average peel strength values for each primary surface of a test sample. Average the three average peel strength values to obtain the “average adhesion strength” for the facer on a specific primary surface of a faced foam. It is desirable that a composite facer adheres sufficiently to a foam core to cause cohesive failure of the foam upon delamination, as opposed to simply adhesive failure between the facer and foam surface.

The composite facer is “structurally enhancing”, meaning it increases the physical strength of a foam core. Characterize physical strength using an Average Max Load value from a Spherical Indentation Test. Conduct the Spherical Indention Test on a 10-inch by 10-inch square test specimen of foam or RPFC using a universal compression testing apparatus (e.g., Instron Model 1125 or equivalent) fitted with a 2-inch diameter steel rod that has an exposed end rounded into a 2-inch diameter sphere. Trim and discard a two-inch strip from all edges of a foam or RPFC and then cut three 10-inch by 10-inch square test specimens from the foam board or RPFC. Condition the test specimens at 23±2° C. and 50±5% relative humidity for 24 hours prior to testing. For testing, mount a test specimen centrally between two square steel frames having a 10-inch by 10-inch square outer dimension and a 7-inch by 7-inch inner opening (i.e., a steel frame comprising 1.5-inch rails and stiles). The test specimen should be secured between the frame so as to not slip or move during the test. Calibrate the universal testing apparatus and set the crosshead speed to 10-inches per minute. Position the mounted test specimen in the compression testing machine so that the rounded end of the spherical indentor contacts the center of the test specimen. Compress the specimen until reaching a deflection of 2-inches or until the sample breaks, whichever occurs first. Record the maximum load (“Max Load”) the universal testing apparatus records during the test. Repeat the process with the remaining two test specimens. An average of the Max Load values for the three test specimens is the Average Max Load value of the foam board or RPFC. A higher Average Max Load value corresponds to a higher physical strength. Generally, a RPFC of the present invention has an Average Max Load value of at least 75 pounds, preferably at least 100 pounds, more preferably at least 150 pounds and can have values of 200 pounds or more. Testing should occur at 23±2° C. and 50±5% relative humidity.

Desirably, a four foot long and one foot wide RPFC of the present invention can be folded along a bend that is perpendicular to the RPFC's length and such that a portion of the RPFC's first primary surface is folded back on itself without fracturing the foam core of the RPFC or delamination of the RPFC's composite facer.

The thermoplastic polymer film layer comprises 50 wt % or more, preferably 70 wt % or more, more preferably 90 wt % or more of a thermoplastic polymer resin, based on thermoplastic polymer film layer weight. The thermoplastic polymer film layer can be 100 wt % thermoplastic polymer resin. Desirably, the thermoplastic polymer film layer is adhesively compatible with the foam core, which means that the polymer film layer can adhere to the foam core by, e.g., thermal adhesion, without needing an additional adhesive.

Suitable polymer resins for the thermoplastic polymer film layer include those that are suitable for the foam core (e.g., alkenyl aromatic polymers such as polystyrene and aliphatic polymers such as polyethylene and polypropylene). Alkenyl aromatic polymers are particularly desirable, especially for use with alkenyl aromatic polymer foam cores, because they have a relatively high modulus that manifests itself in a stronger film relative to many aliphatic polymers and because they tend to readily thermally adhere (e.g., thermally laminate or melt-weld) to alkenyl aromatic polymer foam cores. Desirably, the polymer film layer comprises a toughening polymer such as high impact polystyrene (HIPS), ethylene-styrene interpolymer (ESI), block copolymers of styrene with isoprene such as styrene-isoprene-styrene (SIS) block co-polymers, block copolymers of styrene with butadiene such as styrene-butadiene-styrene (SBS) block copolymers, saturated butadiene-styrene copolymers (SEBS). Combinations of any of the suitable polymers are also acceptable.

The thermoplastic polymer film layer can have any technically achievable thickness. Usually, the thermoplastic polymer film layer has a thickness of about 0.5 mil or more, preferably of about 0.9 mil or more and more preferably of about 1 mil or more. Generally, the thermoplastic polymer film layer has a thickness of about 4 mil or less, preferably of about 1.5 mil or less, more preferably of about 1.3 mil or less. Thermoplastic polymer film layers having a thickness of less than about 0.5 mil tend to lack structural integrity, while thermoplastic polymer film layers thicker than about 4 mil tend to be unnecessarily expensive and increase RPFC density.

The polymeric film typically covers 75% or more, preferably 95% or more, more preferably all of a foam core's primary surface.

The gas-breathable layer of a composite facer resides between a foam core and a thermoplastic polymer film layer of a RPFC. This configuration is particularly desirable over other configurations. Sandwiching the gas-breathable layer between the foam core's primary surface and thermoplastic polymer film layer protects the gas-breathable layer from unweaving or being pulled apart or otherwise damaged during manufacture, handling or use of the RPFC. In contrast, U.S. Pat. No. 6,536,176 (incorporated herein by reference) discloses polymeric foam and scrim sheathings that have an exposed scrim. The exposed scrim requires reinforcing on its periphery so as to inhibit failure of the sheathing. The breathable polymer layer of the present invention can be free of peripheral reinforcement, particularly as described in U.S. Pat. No. 6,536,176.

The gas-breathable layer is a structure comprising greater than 50 wt % thermoplastic polymer (based on total weight of the gas-breathable layer) that has defined therein openings or passages through which gas can travel. It is particularly desirable for the gas-breathable layer to have a non-distinguishable difference in permeability rate for air and halogenated hydrocarbon blowing agents as measured by International Nonwovens and Disposables Association (INDA) Standard Test 70.1-70 when testing permeability under sufficient conditions for both air and halogenated hydrocarbon blowing agent to be in gaseous form. Preferably, the halogenated hydrocarbon blowing agent used in the test method is 1-chloro-1,1-difluoroethane (HFC-142b). Suitable forms of gas-breathable layers include slit or perforated films, woven and non-woven sheets, scrims and nets, combinations of individual strips of film, strands of fiber, open-celled foams (i.e., having at least 20% open-cell content, preferably at least 50% open-cell content, more preferably at least 80% open-cell content according to ASTM D2856-A) and combinations thereof.

“Gas-breathable” layers have openings and/or passages defined through them. The openings and/or passages have a smallest dimension of 0.05 mil or larger, preferably 0.01 inches or larger, more preferable 0.03 inches or larger. Every square inch of a primary surface of a gas-breathable layer has access to at least one such opening and/or passage. Every 0.5 square inch, even every 0.25 square inch of a gas-breathable layer's primary surface can have access to such an opening and/or passage. For example, a scrim comprising 0.03 inch diameter strands spaced 0.25 inches apart provides access to at least four openings over every square inch of the scrim's primary surface and at least one opening every 0.25 square inch of the scrim's primary surface.

In contrast, solid films and solid coatings do not fall within the definition of a gas-breathable layer. While solid films and solid coatings may have some permeability to select gases, those gases permeate through the film or coating on a molecular level. Solid films and solid coatings do not have openings or passages with a dimension of 0.05 mil or larger defined in them and at a frequency so to allow access to such an opening or passage on any square inch of the film or coating. Therefore, solid films and solid coatings are not considered “breathable.” Desirably, RPFCs of the present invention are free of solid films and solid coatings between a foam surface and a gas-breathable layer of a composite facer affixed to that foam surface.

The gas-breathable layer typically extends over an entire primary surface of a foam core. However, a gas-breathable layer can contain a multitude of holes or openings that allow a portion, even 50% or more of a foam core's primary surface to remain exposed though the gas-breathable layer. For example, a net that covers an entire primary surface of a foam core allows the primary surface to remain exposed through openings in the net.

Scrims and nets are particularly desirable as gas-breathable layers because they are efficient reinforcing structures. That is, the reinforcing contribution per unit volume of polymer is higher for scrims and nets than other gas-breathable materials. Scrims and nets can have woven or knit polymer members. Scrim and net members can include, e.g., strands and tapes. Strands tend to have a relatively round or oval cross-section while tapes have more of a flat or elongated cross-section. Scrim and net members can be solid, hollow or even have perforations therethrough. Generally, scrim and net members are solid.

Scrims and nets containing members that adhere to one another at points of intersection (“adhered scrims” or “adhered nets”) tend to be more robust in handling than those whose members do not adhere to one another. Adhered scrims and nets comprising woven and adhered tapes tend to be more robust than those comprising adhered strands. Adhered scrims and adhered nets are especially desirable since they do not tend to unravel or unweave during handling. Furthermore, adhered scrims and nets are likely to distribute energy more efficiently throughout their structure than those scrims and nets without bound members, thereby enhancing the structure's reinforcing ability. Strands typically adhere to one another by melt-welds or an adhesive where they intersect.

Desirably, a scrim or net that is useful as a gas-breathable layer has a weight-per-unit-area of about 0.5 pounds per thousand square feet (lb/msf) or more, preferably about one lb/msf or more, and can be about 1.25 lb/msf or more. Desirably, the scrim or net has a weight-per-unit-area of about 18 lb/msf or less, preferably about 10 lb/msf or less, more preferably about 4.5 lb/msf or less, still more preferably about two lb/msf or less. Scrim and net having a weight-per-unit-area of less than 0.5 lb/msf is very difficult to make and does not offer much structural reinforcement, while above 18 lb/msf it becomes economically undesirable.

Scrims and nets desirably have holes between strands of about 0.001 square inches (in²) or more, preferably of about 0.01 in² or more, more preferably of about 0.1 in² or more and of about four in² or less, preferably of about one in² or less, and more preferably of about 0.25 in² or less. The holes can be of any shape. Decreasing the hole area between strands is desirable to increase the strength of a scrim or net. It is also desirable for the gas-breathable layer to have holes that have a shape, a size, or both a shape and size such that heads of nails or screws that may be used to affix an RPFC containing the gas breathable layer to a building structure cannot fit through the holes without damaging the gas-breathable layer. Such a gas-breathable layer reinforces the RPFC against nail pull through. Holes between strands can be of any shape, but are typically square, rectangular, or diamond-shaped (i.e., four-sided-figure with corners other than 90° and opposing corners having similar angles).

Greater than 50 wt %, preferably 75 wt % or more, more preferably 90 wt % or more of a gas-breathable layers is a thermoplastic polymer resin, based on total gas-breathable layer weight. A gas-breathable layer can be 100 wt % thermoplastic polymer resin, based on gas-breathable layer weight. Particularly desirable thermoplastic polymer resins for use in gas-breathable layers include alkenyl aromatic polymers, propylene polymers and ethylene polymers.

A gas-breathable layer is important in the present invention to serve at least one of two functions. First, it can serve to further enhance the strength of a RPFC over a polymer film layer alone. Second, it can assist in forming venting means in the RPFC, discussed further below. The gas-breathable layer can also enhance the durability of the facer when bound to the polymer film layer prior to manufacturing the RPFC, thereby reducing a likelihood of facer web breaks during RPFC manufacturing.

A preferred embodiment of the present invention contains venting means. Venting means are avenues that provide gaseous communication or transport from between a thermoplastic polymer film layer and a foam core of a RPFC to an atmosphere around the RPFC. Venting means are desirable to reduce or eliminate gas pressure from building up between a film layer and a foam core. Such a build up of pressure can promote delamination of the film from the foam. RPFCs of the present invention that contain venting means have a lower likelihood of experiencing facer delamination from a foam core than RPFCs without venting means.

Venting means include, e.g., venting channels between the thermoplastic polymer film layer and foam core's primary surface, as well as perforations through the thermoplastic polymer film layer. Generally, venting channels are more desirable over perforations through the thermoplastic polymer film layer since such perforations can diminish the film layer's integrity and, hence, lower the reinforcing capability of the film layer. RPFCs can have a combination of venting means, such as both venting channels and perforations in the thermoplastic polymer film layer.

Venting channels are paths between a thermoplastic polymer film layer and foam core's primary surface. Venting channels can reside above a primary surface of a foam core (i.e., between a foam core's primary surface and the film of the facer attached the foam surface), within a primary surface of a foam core, or a combination of both above and within a primary surface of a foam core. Preferably, venting channels are located above a primary surface of a foam core, more preferably above a substantially planar primary surface of a foam core. Venting channels that reside above a foam core's primary surface are pathways defined by sections of composite facer that rise above the primary surface. In contrast, venting channels residing within a primary surface are defined within a foam core and can be in the form of, e.g., grooves, slots, channels that are milled or molded into the primary surface. Defining venting channels within a foam core's primary surface can diminish the foam core's structural integrity. Therefore, venting channels desirably reside mostly, if not entirely, above a foam core's primary surface. A venting channel resides “mostly” above a foam core's primary surface if greater than 50 percent of the channel's volume resides above a plane defined by the majority of the foam's primary surface.

In one embodiment, venting channels above a foam core's primary surface extend along structural members of a gas-breathable layer. Structural members include strands that comprise a net or scrim. Structural members also include strands or webbing that comprise a woven material. Venting channels can result from incomplete contact between the thermoplastic polymer film layer and a foam core's primary surface along the structural members of a gas-breathable layer.

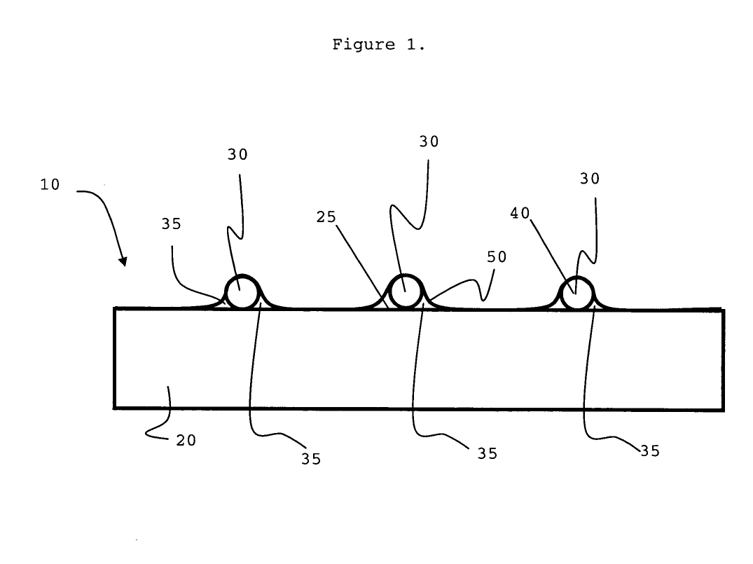

As an example, FIG. 1 illustrates venting channels 35 on a magnified edge-on view of a cross section of RPFC 10. RPFC 10 contains foam core 20, strands 30 of polymeric scrim 40, thermoplastic polymer film layer 50, and venting channels 35. Polymeric scrim 40 is the gas-breathable layer of RPFC 10. Thermoplastic polymer film layer 50 contacts a primary surface 25 of foam core 20 except directly proximate to strands 30. The spaces between where thermoplastic polymer film layer 50 contacts primary surface 25 and strands 30 constitute venting channels 35. Venting channels can also exist between film layer 50 and strands 30, between strands 30 and primary surface 25, or a combination thereof.

Venting means desirably traverse a primary surface of a foam core, preferably in more than one direction, and extend to edges of a RPFC. Preferably, a RPFC of the present invention has a venting means within every square inch or less, preferably every 0.25 square inch or less over its primary surface. The extent of venting means over a primary surface of a RPFC is only limited by an ability to provide sufficient adhesive strength between the composite facer and the foam core. Sufficient adhesive strength is an average adhesion strength of at least about 25 grams per inch (g/in), preferably at least about 50 g/in, more preferably at least 75 g/in, and still more preferably at least 100 g/in, according to a Facer Adhesion Strength Test Method. Minimizing the area without access to a venting means is desirable to maximize venting of gas from between the foam core and thermoplastic polymer film layer, thereby reducing the likelihood of delamination of the thermoplastic polymer film layer.

An RPFC of the present invention may have a second facer on a primary surface opposite that having a composite facer attached thereto. A particularly desirable embodiment of the present invention comprises a foam core with a composite facer on two opposing primary surfaces of a foam core. The composite facers can have the same or different composition provided they both comprise a breathable polymer layer between the foam core's primary surface and a thermoplastic polymer film layer. Desirably, the structurally enhancing composite facers on opposing primary surfaces of a foam core have similar, more preferably identical composition so as to balance tension on a foam core. Thermoplastic foam cores that have different tensions on opposing primary surfaces can tend to warp as environmental conditions (e.g., temperature) change.

When a RPFC of the present invention has a composite facer on two opposing primary surfaces, venting means may be present on only one or, preferably, on both surfaces.

Composite facers of the present RPFCs can include layers in addition to the thermoplastic polymer film layer and the gas-breathable layer, provided the resulting composite facer is recyclably compatible with the RPFC's foam core. For example, a composite facer can comprise multiple thermoplastic polymer film layers, multiple gas-breathable layers, an adhesive layer or coating between the film layer and gas-breathable layer, an adhesive layer or coating between the gas-breathable layer and the foam core, or any combination thereof. Different layers of the composite facer can comprise the same polymer or different polymers.

An adhesive can exist between any layers in the present invention. An adhesive can be a “layer”, which means it covers 50% or more of a foam core's primary surface or a “coating”, which means it covers less than 50% of a foam core's primary surface. As a caveat to this definition of “layer” and “coating”, a gas-breathable layer is considered a “layer” even though it may have sufficient holes to leave more than 50% of a foam core's primary surface exposed through it. Generally, an adhesive layer is in a form of an adhesive film. Desirably, any adhesive film residing between a foam core's primary surface and a gas-breathable layer is sufficiently permeable to allow blowing agent in the foam core to escape through any venting means that may be present.

Suitable adhesives for use in the present invention include ethylene/vinyl acetate, ethylene/ethyl acrylate, ethylene/n-butyl acrylate, ethylene/methylacrylate, ethylene ionomers, ethylene or propylene graft anhydrides, saturated and unsaturated block copolymers of styrene with butadiene and styrene with isoprene, and acrylic polymers. Preferably, adhesives comprise five wt % or less, more one wt % or less of total RPFC weight.

One or more of the layers of the composite facers can, independent of the others, have orientation in one or more directions. Orientation is particularly desirable in the thermoplastic polymer film layer, gas-breathable layer, or both so as to enhance their strength and the strength of a RPFC.

Each layer of a composite facer can, independent of one another, contain any common additives provided the additive does not obviate the recyclability of the composite facer with the foam core. Common additives include pigments; infrared blocking agents such as carbon black; flame-retardants; processing aids; and ultraviolet stabilizers. Additives are present in any given layer at a concentration of 0 to about 20 wt % based on layer weight, provided the resulting RPFC remains recyclable into a polymeric foam core.

A necessary feature for RPFCs of the present invention is that they be recyclable into a foam core. Determine if a RPFC is “recyclable into a foam core” by using the following “Recyclability Test”:
Prepare recycle pellets by: (1) comminuting a RPFC (“recycled RPFC”) into pieces having a largest dimension of less than 0.5 inches and a smallest dimension of at least 0.125 inches; and then (2) converting the comminuted pieces into pellets via a continuous or void-free solid recycle resin mixture using an extruder with at least one devolatilizing or decompression zone that is vented to the atmosphere followed by pulverizing or pelletizing the solid recycle resin mixture into pellets having a smallest dimension of no less then 0.0625 inches. U.S. Pat. No. 3,795,633 (incorporated herein by reference) provides exemplary teachings of a process suitable for preparing recycle pellets.
Form a polymer blend by mixing at least 20 wt % recycle pellets with virgin polymer resin comprising the balance to 100 wt %, wt % being relative to total polymer blend weight.
If the polymer blend can be foamed into a close-celled foam core having a substantially planar primary surface; essentially the same composition as the foam core of the recycled RPFC; and a density within 10% of the foam core of the recycled RPFC then the recycled RPFC is “recyclable into a foam core”. Measure foam density according to American Society for Testing and Materials (ASTM) method D-1622. Measure open cell content according to ASTM method D-6226. “Essentially the same composition” means having within the same additives present at within 10% of their wt % in the Recycled RPFC foam core and being free of any additional additives except for degredation products arising from subjecting the Recycled RPFC to the Recyclability Test.

The Recyclability test is not limited to a specific foaming process. However, the Recyclability Test preferably uses the same foam process (perhaps with different operating parameters, though most preferably with similar or same operating parameters) used to prepare the foam core of the Recycled RPFC.

Desirably, a RPFC is recyclable into a foam core according to the Recyclability Test when using 40 wt % or more, or 60 wt % or more, or even 100 wt % of recycle pellets, based on total weight or resin used to prepare the foam core.

For a RPFC to be recyclable into a foam core, its composite facer(s) must be recyclably compatible with its foam core (i.e., a combination of the facer composition(s) and foam core are recyclable into a foam core). Therefore, selection of polymer compositions for the thermoplastic polymer film layer and gas-breathable layer (and any additional layers) of the composite facer is dependent upon selection of polymer composition of the foam core, and vice versa. In this light, scrims and nets are particularly useful as gas-breathable layers because they can provide for incorporation of a highly reinforcing polymer that is not recyclably compatible with a foam core as a full film but is recyclably compatible with a foam core at a volume of a scrim or net.

Identification of a recyclably compatible facer composition for a specific foam core composition is somewhat of an art and is best determined empirically through experimentation. As a general rule, if a composite facer consists essentially of the same polymer composition as a foam core, the composite facer and foam core are recyclably compatible. If a composite facer consists essentially of a polymer or polymer blend that has a crystalline melting point, or glass transition temperature for amorphous polymers, within 100° C., preferably within 50° C., more preferably within 20° C. of the foam core's polymer composition then the composite facer more than likely is recyclably compatible with the foam core. If, however, the polymer composition of the composite facer is not miscible with the polymer composition of the foam core, then the composite facer is only recyclably compatible with the foam core if it can be dispersed into sufficiently small particle sizes in the foam polymer resin during the recyclability test so as to pass the recyclability test.

It is impractical to try addressing all possible combinations of recyclably compatible composite facer/foam core combinations. A skilled artisan can identify such concentrations without undue experimentation.

As an exemplary guideline, recyclably compatible composite facers for use in an RPFC with a polystyrene core can generally contain unlimited amounts of polystyrene and ESI, up to about 15 wt % polypropylene, and generally up to about 20 wt % polyethylene, with wt % relative to total RPFC weight.

As an exemplary composition, an RPFC can have a foam core and thermoplastic polymer film layer, each comprising independently (i.e., not necessarily the same polymer for each) an alkenyl aromatic polymer, and a polypropylene gas-breathable layer. The thermoplastic polymer film layer, gas-breathable layer, or both can be oriented in one or two directions.

As another example, a RPFC can have a foam core and thermoplastic polymer film layer, each comprising independently an alkenyl aromatic polymer, and a gas-breathable layer comprising a polyethylene polymer (e.g., LLDPE). Again, the thermoplastic polymer film layer, gas-breathable layer, or both can be oriented in one or two directions.

However, facers comprising a layer of PET film, metal foil, and/or paper are not recyclably compatible with a thermoplastic foam core. An RPFC comprising a layer of PET film and/or a layer of metal foil and/or a layer of paper does not meet the requisite recyclability requirement of the present invention. Therefore, in order to be recyclable into a foam core according to the Recyclability Test, RPFCs of the present invention are free of a PET film layer, a metal foil layer, a layer of paper, or any combination thereof.

The composite facer of the present invention advantageously allows incorporation of highly reinforcing polymers that are not easily recyclably compatible with a foam core in a manner that enhances a RPFC's strength while maintaining the RPFCs recyclability into a foam core. Incorporating such a polymer in the form of a gas-breathable layer strategically uses the polymer to enhance a RPFC's strength while minimizing the amount of the polymer in the RPFC. For example, biaxially oriented polypropylene (BOPP) is a tough and durable material that is recyclable with polystyrene foam only in quantities less than can readily be formed into a continuous film facer. Therefore, reinforcing a polystyrene foam with a BOPP film facer is desirable, but not possible while maintaining recyclability. Nonetheless, combining a 1.5 lb/msf biaxially oriented PP net (each PP strand is oriented in the direction in which it extends) with a 1.2 mil thick film of polystyrene to form a composite facer for a polystyrene foam produces a more durable reinforced polymer foam composition than a polystyrene foam reinforced with an even thicker 1.5 mil thick polystyrene film face alone. In both cases, the RPFC is recyclable into a foam core. Example 1 and Comparative Example A illustrate this in more detail below.

Desirably, RPFCs of the present invention are essentially free, preferably completely free of one or more material selected from a group consisting of metal foil; paper; polyester, particularly PET; nylon; thermosetting polymeric materials; glass, mineral and metal fibers longer than one centimeter in length and greater than 20 micrometers in diameter; and thermoplastic polymers with crystalline melting points or glass transition temperatures greater than 200 degrees Celsius (° C.) unless the material selected from said group is present in particulate form wherein each particulate has a volume of no more than one cubic millimeter, more preferably no more than 0.1 cubic millimeters, even more preferably no more than 0.01 cubic millimeters. Such materials are particularly difficult to recycle into a foam core. To be “essentially free” of a component means that the component, if present, is at a low enough concentration to have a negligible effect on recyclability of the RPFC into a foam.

Prepare RPFCs of the present invention by affixing a thermoplastic polymer film layer and a gas-breathable layer to a primary surface of a foam core such that the gas-breathable layer is between the thermoplastic polymer film layer and the foam core. It is possible to affix the thermoplastic polymer film layer and gas-breathable layer to a foam core independent of one another thereby forming a composite facer in situ on the foam core. Alternatively, affix the thermoplastic polymer film layer and gas-breathable layer to one another to form a composite facer prior to affixing to a foam core. When forming a composite facer in situ on a foam core, layers of the composite facer can remain unbound to one another. For example, affixing a thermoplastic polymer film layer to a foam core through holes in a gas-breathable layer can affix a composite facer to a foam core without affixing the thermoplastic polymer film layer to the gas-breathable layer.

It is acceptable to affix layers of a composite facer to each other, to the foam core, or both to each other and to the foam core. There are many suitable means for affixing the layers to each other and/or to the foam core including thermally adhering (i.e., melt-welding or thermally laminating), by means of an adhesive, or a combination of thermally adhering and an adhesive. When thermally adhering a composite facer to a primary surface of a foam core, it is acceptable to thermally adhere a thermoplastic polymer film layer to both a gas-breathable layer and a foam core or just to the foam core through holes or openings in the gas-breathable layer. Alternatively, thermally adhere a polymeric film to a gas-breathable layer to form a distinct composite facer and then affix composite facer in turn to the foam core (e.g., by affixing the polymeric film, gas-breathable layer, or both to the foam core by use of an adhesive or thermal adhesion). When a composite facer adheres to a foam core by thermal adhesion, the RPFC can be free of adhesives.

In one preferred embodiment, a composite facer adheres to a foam core by means of both thermal adherence and an adhesive. One example within this embodiment contains a gas-breathable layer that has an adhesive on one or both of its primary surfaces to enhance adhesion to the foam core, the polymer film layer, or both while the polymer film layer thermally adheres to the foam core through the gas-breathable layer. U.S. Pat. No. 4,410,587 (incorporated herein by reference) discloses structures that include an adhesive component as part of each structure's composition; such structures are suitable for use as gas-breathable layers within the scope of this preferred embodiment.

RPFCs of the present invention are particularly useful as RFSs by affixing them to a building structure, particularly as wall components. Nailing, screwing, stapling, gluing and combinations thereof are all suitable methods of affixing the RPFS to a wall structure. Wall structures include, e.g., two-by-four frame structures. RPFCs of the present invention can also find utility, e.g., as reinforced insulating wraps for packing boxes and insulating sheathing for concrete frameworks.

The following examples serve to further illustrate specific embodiments the present invention.

### COMPARATIVE EXAMPLE A

Use as a foam core a 12 inch square, 0.55 inch thick extruded polystyrene foam having an average cell size of 0.2 mm and a density of 1.6 PCF.

Use as a thermoplastic polymer film layer a 1.5 mil thick high impact polystyrene film (e.g., TRYCITE® 8003, TRYCITE is a trademark of The Dow Chemical Company). The thermoplastic polymer film layer is slightly larger in dimensions than the 12 inch square primary surface of the foam core.

Lay the thermoplastic polymer film layer on a primary surface of the foam core and heat laminate it to the foam core using a hot roll laminator (e.g., Chemsultants International 18-inch laminator) using a polytetrafluoroethylene sheet as a release sheet between the hot rollers and the resulting RPFC. Set the laminator gap to 0.5 inches, the hot roll temperature to 275° F., the speed to 8-10 feet per minute, and the compressive pressure on the hot roll to 10 pounds-per-square-inch (psi). Laminate a second thermoplastic polymer film layer to an opposing primary surface of the foam core.

### EXAMPLE 1

Use a foam core as in Comparative Example A.

Use as a thermoplastic polymer film layer a 1.0 mil thick high impact polystyrene film (e.g., TRYCITE 8003)

Use as a gas-breathable layer a 1.5 lb/msf biaxially oriented PP net containing an EVA adhesive as 10 wt % of the total net weight on one surface of the net and a strand spacing of two strands per inch in the machine direction and three strands per inch in the cross direction (e.g., Conwed Plastics part number 750012-004). The gas-breathable layer is of slightly larger dimensions than the 12 inch square primary surface of the foam core.

Lay the gas-breathable layer and thermoplastic polymer film layer on a primary surface of the foam core such that the gas-breathable layer is between the thermoplastic polymer film layer and the foam core and such that the adhesive surface of the gas-breathable layer is against the foam core. Heat-laminate the two layers to the foam core using a hot roll laminator as in Comparative Example A. Repeat the lamination procedure to affix a composite facer to an opposing primary surface of the foam core. Adhesion of the composite facer to the foam core is sufficient to cause cohesive failure of the foam upon delamination of the facer from the foam. The resulting RPFC (Example 1) is recyclable into a foam core.

Compare the physical strength of Example 1 to that of Comparative Example A using a Spherical Indentation Test. Comparative Example A has an Average Max Load value of 184 pounds (from five samples). Example 1 has an Average Max Load value of 211 pounds (from three samples).

Example 1 and Comparative Example A illustrate that a structure containing a composite facer having a film and a gas-breathable layer can provide a recyclable RPFC having greater physical strength than recyclable reinforced foam composition having only a film facer, even when the film facer is thicker than the thermoplastic polymer film used in the composite facer.

### EXAMPLE 2

Use as a gas-breathable layer a 1.5 lb/msf polypropylene (PP) net with square openings defined by PP strands at three stands per inch frequency in each of two orthogonal directions. PP strands are affixed together at points of intersection. The PP net is biaxially oriented, meaning each PP strand is oriented in the direction it extends.

Use as a thermoplastic polymer film layer a 0.7 mil BOPP film (e.g., P/N 696799 from American National Can)

Use as a foam core a one inch thick coalesced strand foam that has a density of one PCF (e.g., PROPEL® 9-15, PROPEL is a trademark of The Dow Chemical Company).

Lay the gas-breathable layer and thermoplastic polymer film layer on a primary surface of the foam core such that the gas-breathable layer is between the thermoplastic polymer film layer and the foam core. Heat laminate the two layers to the foam core using a hot roll laminator (e.g., Chemsultants International 18-inch laminator) using a polytetrafluoroethylene sheet as a release sheet between the hot rollers and the resulting RPFC. Set the laminator gap to 0.9 inches, the hot roll temperature to 300° F., the speed to 3 feet per minute, and the compressive pressure on the hot roll to 10 pounds-per-square-inch. The resulting RPFC demonstrates sufficient peel strength between the composite facer and the foam to result in cohesive failure between the foam's surface cells.

Example 2 illustrates a RPFC of the present invention having a PP foam core, polypropylene gas-breathable layer, and a polypropylene polymeric film layer. Example 2 also illustrates a process for preparing a RPFC by forming a composite facer in situ on a foam core.

Example 2 can equally well contain a composite facer on opposing primary surfaces of the PP foam core by orienting a gas-breathable layer between a polymer film layer an opposing primary surface opposing the of the foam core and then repeating the heat lamination process.

### EXAMPLE 3

Use as a gas-breathable layer a 1.5 lb/msf LLDPE net with EVA (10 wt % of total net weight) on the thermoplastic polymer film side of the net and a strand spacing of three strands per inch in both the machine direction and cross direction (e.g., part number 810271-L41 from Conwed Plastics).

Use as a thermoplastic polymer film layer a 1.2 mil thick biaxially oriented film of 65 wt % polystyrene/35 wt % ESI, wt % based on film weight (e.g., XUS 65089.01, available from The Dow Chemical Company).

Use as a foam core a 0.55 inch thick extruded polystyrene foam that has an average cell size of 0.2 millimeters and a density of 1.6 PCF.

Heat laminate the film layer to the gas-breathable layer using a 220° F. hot roll laminator so that the EVA coating on the gas-breathable layer contacts the thermoplastic polymer film layer.

Heat-laminate the composite facer onto the foam core by placing the gas-breathable layer against a primary surface of the foam core. Using a heat laminator as in Example 2, set the roll temperature to 316° F., rate to 70 feet per minute and a gap spacing of 0.525 inches.

Example 3 illustrates a RPFC of the present invention that contains a polystyrene foam core, a polyethylene gas-breathable layer, and an ESI film layer. Example 3 also illustrates a process for preparing a RPFC that involves forming a composite facer apart from a foam core. Example 3 is recyclably compatible in the Recylability Test at a loading of at least 30 wt % recycle pellets, based on total resin weight.

### EXAMPLE 4 AND COMPARATIVE EXAMPLE B

Prepare Example 4 and Comparative Example B using a polystyrene foam as in Example 3 for a foam core. Modify the foam for each of Example 4 and Comparative Example B by perforating the surface with pinholes spaced 0.5 inches apart and 0.3 inches deep prior to laminating with a thermoplastic polymer film layer.

Use a one mil thick polystyrene film (e.g., TRYCITE 8003, available from The Dow Chemical Company) as a thermoplastic polymer film layer.

Prepare Comparative Example B by heat laminating the polystyrene film to a primary surface of the polystyrene foam using a hot roll laminator (as in previous Examples) with a laminator gap set at 0.5 inches, hot roll temperature at 275° F., feed speed set between 8 and 10 feet per minute, and compressive pressure of the hot roll set to 10 psi. Laminate a polystyrene film on the opposing primary surface of the foam in the same way.

Prepare Example 4 in a similar way as Comparative Example B, except place a 4.5 lb/msf polypropylene net with 10 wt % EVA adhesive on the foam side of the net and a strand spacing of four stands per inch in both machine and cross directions (e.g., part number 750012-010, available from Conwed Plastics) between the film layer and foam core prior to laminating. The polypropylene net acts as a gas-breathable layer. Include the net on both sides of the foam core. Venting means reside along structural members of the polypropylene net.

Peeling of the film layer away from the foam core results in cohesive failure of the foam surface rather than adhesive failure of the film to foam for both Example 4 and Comparative Example B.

Delamination testing of Example 4 and Comparative Example B where samples of each are placed in an oven at 185° F. for 24 hours results in sporadic delamination of the film layer from the foam core in Comparative Example B, but no visible delamination of the polymer film from Example 4.

Example 4 illustrates an RPFC of the present invention comprising a polystyrene foam core, polypropylene gas-breathable layer, and a polystyrene thermoplastic film layer. Example 4 also illustrates an RPFC of the present invention that has a lower likelihood of facer delamination than a similar composition without the gas-breathable layer (and venting means resulting from incorporation therein).

1. A reinforced polymer foam composition comprising a closed-cell foam core having opposing first and second primary surfaces and a structurally enhancing composite facer attached to at least one of the primary surfaces, said composite facer comprising a thermoplastic polymer film layer and a gas-breathable layer, the gas-breathable layer residing between said foam core and said thermoplastic polymer film, and wherein:
(a) said foam core comprises a thermoplastic polymer resin having a plurality of cells defined therein, said resin containing at least 50 weight-percent, by weight of resin, of a polymer selected from a group consisting of alkenyl aromatic polymers and polypropylene;
(b) said reinforced polymer foam composition is recyclable into a foam core according to a Recylability Test; and
(c) said reinforced polymer foam composition is free of a polyethylene terephthalate film layer, a metal foil layer, a layer of paper, or any combination thereof.

2. The reinforced polymer foam composition of claim 1, wherein said foam core comprises a polymer resin containing at least 50 weight-percent, by weight of resin, of an alkenyl aromatic polymer and said foam core is close-celled.

3. The reinforced polymer foam composition of claim 1, wherein said reinforced polymer foam composition further comprises venting means that allow passage of gas from between the foam core and composite facer's thermoplastic polymer film layer to an atmosphere surrounding the composition.

4. The reinforced polymer foam composition of claim 2, wherein said venting means comprise venting channels that reside mostly above the primary surface of the foam core to which the composite facer attaches.

5. The reinforced polymer foam composition of claim 1, wherein said reinforced polymer foam composition having a structurally enhancing composite facer attached to two opposing primary surfaces.

6. The reinforced polymer foam composition of claim 1, wherein said composition is essentially free of materials selected from a group consisting of metal foil; paper; polyethylene terephthalate; nylon; and glass, metal and mineral fibers longer than one centimeter in length and greater than 20 micrometers in diameter unless the material is in particulate form and each particulate has a volume of no more than one cubic millimeter.

7. The reinforced polymer foam composition of claim 1, wherein the gas-breathable layer comprises a polymeric scrim.

8. The reinforced polymer foam composition of claim 1, wherein the foam and film both comprise an alkenyl aromatic polymer.

9. The reinforced polymer foam composition of claim 1, wherein the gas-breathable layer comprises at least 50 weight-percent, based on gas-breathable layer, of a polymer selected from a group consisting of alkenyl aromatic polymers, polypropylene and polyethylene.

10. The reinforced polymer foam composition of claim 1, wherein the foam core and thermoplastic polymer film layer comprise independently an alkenyl aromatic polymer, the gas-breathable layer comprises a polypropylene polymer and wherein the gas-breathable layer comprises 15 weight-percent or less of the total reinforced polymer foam composition weight.

11. The reinforced polymer foam composition of claim 10, wherein the gas-breathable layer is biaxially oriented.

12. The reinforced polymer foam composition of claim 1, wherein the foam core and thermoplastic polymer film layer comprise independently an alkenyl aromatic polymer, the gas-breathable layer comprises a polyethylene polymer and wherein the gas breathable layer comprises 20 weight-percent or less of the total reinforced polymer foam composition weight.

13. The reinforced polymer foam composition of claim 12, wherein the polyethylene polymer is linear low-density polyethylene.

14. The reinforced polymer foam composition of claim 1, wherein the composition is free of a solid film or solid coating between the foam core's primary surface and the gas-breathable layer of the composite facer affixed to that foam core surface.

15. A process for preparing the reinforced polymer foam composition of claim 1, said process comprising affixing the structurally enhancing composite facer comprising the thermoplastic polymer film layer and the gas-breathable layer to a primary surface of the foam core such that the gas-breathable layer is between the thermoplastic polymer film layer and the foam core.

16. The process of claim 15, wherein affixing comprises thermally adhering the film layer through the gas-breathable layer to the foam core.

17. The process of claim 15, wherein affixing comprises thermally adhering the film layer and gas-breathable layer to the foam core.

18. The process of claim 15, further comprising affixing the gas-breathable layer to the thermoplastic polymer film layer to form a composite facer prior to affixing the gas-breathable layer or thermoplastic polymer film layer to the foam core.

19. A process for using the reinforced polymer foam composition of claim 1 comprising affixing the reinforced polymer foam composition to a building structure.
